(19) United States
(12) Patent Application Publication
(10) Pub. No.: US 2024/0317085 A1
(43) Pub. Date: Sep. 26, 2024

(54) SYSTEM AND METHOD FOR CONTROLLING ELECTRIC POWER OF VEHICLE BATTERY

(71) Applicant: HL MANDO CORPORATION, Gyeonggi-do (KR)

(72) Inventors: Bongyeon CHOI, Gyeonggi-do (KR); Sunghyun LIM, Gyeonggi-do (KR)

(21) Appl. No.: 18/202,274

(22) Filed: May 25, 2023

(30) Foreign Application Priority Data
Mar. 14, 2023 (KR) 10-2023-0033189

(51) Int. Cl. B60L 53/22; H02M 1/12

(52) U.S. Cl. CPC B60L 53/22; H02M 1/126; B60L 2210/40

(57) ABSTRACT

A system for outputting electric power of vehicle battery and a method for driving the same, by removing a harmonic component from an output voltage of a DC-AC inverter through a proportional resonance controller, can remove the harmonic component generated when the DC link capacitance is reduced and can reduce THD (Total Harmonic Distortion), and, by removing the harmonic component generated when the DC link capacitance is reduced through the proportional resonance controller, can reduce the THD while reducing the DC link capacitance, thereby achieving the reduction to manufacturing cost and product size.

### CROSS-REFERENCE TO RELATED APPLICATION

This application claims benefit and priority to Korean Patent Application No. 10-2023-0033189, filed on Mar. 14, 2023, with the Korean Intellectual Property Office, the disclosure of which is incorporated herein in its entirety by reference.

### TECHNICAL FIELD

The present disclosure generally relates to a system for controlling or outputting electric power of vehicle battery and a method for driving the same, and more particularly, to a system and method which can reduce THD (Total Harmonic Distortion) of an output voltage of an electric vehicle battery system.

### BACKGROUND

A vehicle battery output system, so-called V2L (Vehicle to Load), can enable an electric vehicle to provide regular AC power to loads. In the V2L system, the electronic energy of a vehicle battery can be used to supply power to appliances operated on line voltage. For instance, the power drawn from the electric vehicle is made available at a socket outlet which can be located in the cab of the vehicle and/or on an outside of the vehicle. In order to reduce the THD of the output voltage of the V2L system, the stability and the THD of the output voltage can be controlled by increasing a capacitance of a DC link capacitor. However, when the capacitance of the DC link capacitor decreases, a voltage ripple generated in the DC link may increase, and this may cause to lower the THD of the output voltage.

### SUMMARY

Some embodiments of the present disclosure may provide a system for controlling or outputting electric power of vehicle battery and a method for controlling or driving the same, which can reduce or remove a harmonic component from an output voltage of a DC-AC inverter through a proportional resonance controller.

Further, certain embodiments of the present disclosure may provide a system for controlling or outputting electric power of vehicle battery and a method for controlling or driving the same, which can reduce or remove a harmonic component generated when a DC link capacitance is reduced through a proportional resonance controller.

However, the technical objects to be achieved by the present disclosure are not limited to those as described above, and other technical objects may exist.

A system for outputting electric power of vehicle battery, according to one embodiment of the present disclosure, includes: a DC-DC converter for receiving a DC current from a vehicle battery and converting the received DC current into another DC current; a DC-AC inverter for converting the DC current of the vehicle battery converted in the DC-DC converter into an AC current; a controller for generating a control signal for controlling the DC-AC inverter by receiving an output voltage (V_{o_sen}) and calculating a frequency modulation index (m) in which a harmonic component is controlled; and a DC link unit disposed between the DC-DC converter and the DC-AC inverter and including a capacitor.

The controller may calculate the frequency modulation index (m) by subtracting a harmonic modulation index from a voltage frequency modulation index.

The controller may include: a first subtractor for calculating an error by subtracting the output voltage (V_{o_sen}) from a reference voltage (V_{inv_ref}); a voltage controller for receiving the error of the first subtractor and calculating the voltage frequency modulation index by frequency modulation; a proportional resonance controller for receiving the output voltage (V_{o_sen}) and calculating the harmonic modulation index by frequency modulation; and a second subtractor for calculating the frequency modulation index (m) by subtracting the harmonic modulation index from the voltage frequency modulation index.

The system may further include a gate driver for converting an output signal of the controller into an analog signal to control the DC-AC inverter.

The gate driver may output a PWM control signal based on the frequency modulation index (m).

The system may further include a voltage sensor for detecting an output voltage (V_{o_sen}) of an output terminal of the DC-AC inverter and outputting the detected voltage to the controller.

A gain PR of the proportional resonance controller may be expressed by Equation 1 below.

$$PR = {K}_{p} + \frac{{K}_{i} {ω}_{c} s}{{s}^{2} + 2 {ω}_{c} s + {ω}_{z}^{2}} \qquad ( Equation 1 )$$

where Kₚ means a proportional constant for the error, Kᵢ means the gain at a resonant frequency, s means a frequency, ω_{c} means a cutoff frequency, and ω_{z} means the resonant frequency.

The resonant frequency ω_{z} may be expressed by Equation 2 below.

$${ω}_{z} = 2 π {f}_{z} \qquad ( Equation 2 )$$

where f_{z} means a frequency of the harmonic component to be controlled.

The proportional constant Kₚ may be expressed by Equation 3 below.

$$20 log ( {K}_{p} ) < - x \qquad ( Equation 3 )$$

where x means a gain of a vehicle plant model.

The gain Kᵢ at the resonant frequency may be determined using Equation 4 below.

$${\vert {G}_{PR} ( s ) \vert}_{{w}_{z}} \approx \frac{2 \cdot ( {K}_{i} + {K}_{p} ) \cdot {ω}_{z} \cdot {ω}_{c}}{2 \cdot {ω}_{z} \cdot {ω}_{c}} \approx {K}_{p} + {K}_{i} > 0 dB \qquad ( Equation 4 )$$

The cutoff frequency ω_{c} may be determined using Equation 5 below.

$$1 \approx \sqrt{\frac{{( {K}_{i} {ω}_{c}^{2} )}^{2} + {( {K}_{i} {ω}_{c} σ )}^{2}}{{( {σ}^{2} + {ω}_{c}^{2} )}^{2}}} \qquad ( Equation 5 )$$

where σ means a passband at a resonant frequency point.

The controller may receive the output voltage (V_{o_sen}) and calculate the frequency modulation index (m) in which the third harmonic component is controlled.

In a method for driving of a system for outputting electric power of vehicle battery, according to one embodiment of the present disclosure, the system including: a DC-DC converter for receiving a DC current from a vehicle battery and converting the received DC current into another DC current; a DC-AC inverter for converting the DC current of the vehicle battery converted in the DC-DC converter into an AC current; a controller for generating a control signal for controlling the DC-AC inverter by receiving an output voltage (V_{o_sen}) and calculating a frequency modulation index (m) in which a harmonic component is controlled; and a DC link unit disposed between the DC-DC converter and the DC-AC inverter and including a capacitor, the driving method includes allowing the controller to perform the steps of: measuring the output voltage (V_{o_sen}); calculating an error by subtracting the output voltage (V_{o_sen}) from a reference voltage (V_{inv_ref}); calculating a voltage frequency modulation index using the error between the reference voltage (V_{inv_ref}) and the output voltage (V_{o_sen}); calculating a harmonic modulation index using the output voltage (V_{o_sen}); calculating the frequency modulation index (m) by subtracting the harmonic modulation index from the voltage frequency modulation index; and generating a PWM control signal using the frequency modulation index (M).

The controller may include: a first subtractor for calculating an error by subtracting the output voltage (V_{o_sen}) from the reference voltage (V_{inv_ref}); a voltage controller for receiving the error of the first subtractor and calculating the voltage frequency modulation index by frequency modulation; a proportional resonance controller for receiving the output voltage (V_{o_sen}) and calculating the harmonic modulation index by frequency modulation; and a second subtractor for calculating the frequency modulation index (m) by subtracting the harmonic modulation index from the voltage frequency modulation index.

The driving method may further include controlling the DC-AC inverter using the PWM control signal.

A gain PR of the proportional resonance controller may be expressed by Equation 1 below.

$$PR = {K}_{p} + \frac{{K}_{i} {ω}_{c} s}{{s}^{2} + 2 {ω}_{c} s + {ω}_{z}^{2}} \qquad ( Equation 1 )$$

where Kₚ means a proportional constant for the error, Kᵢ means the gain at a resonant frequency, s means a frequency, ω_{c} means a cutoff frequency, and ω_{z} means the resonant frequency.

The resonant frequency ω_{z} may be expressed by Equation 2 below.

$${ω}_{z} = 2 π {f}_{z} \qquad ( Equation 2 )$$

where f_{z} means a frequency of the harmonic component to be controlled.

The proportional constant Kₚ may be expressed by Equation 3 below.

$$20 log ( {K}_{p} ) < - x \qquad ( Equation 3 )$$

where x means a gain of a vehicle plant model.

The gain Kᵢ at the resonant frequency may be determined using Equation 4 below.

$${\vert {G}_{PR} ( s ) \vert}_{{w}_{z}} \approx \frac{2 \cdot ( {K}_{i} + {K}_{p} ) \cdot {ω}_{z} \cdot {ω}_{c}}{2 \cdot {ω}_{z} \cdot {ω}_{c}} \approx {K}_{p} + {K}_{i} > 0 dB \qquad ( Equation 4 )$$

The cutoff frequency ω_{c} may be determined using Equation 5 below.

$$1 \approx \sqrt{\frac{{( {K}_{i} {ω}_{c}^{2} )}^{2} + {( {K}_{i} {ω}_{c} σ )}^{2}}{{( {σ}^{2} + {ω}_{c}^{2} )}^{2}}} \qquad ( Equation 5 )$$

where σ means a passband at a resonant frequency point.

According to some embodiments of the present disclosure, by removing a harmonic component from the output voltage of the DC-AC inverter through the proportional resonance controller, the harmonic component generated when the DC link capacitance is reduced can be removed and THD (Total Harmonic Distortion) can be reduced

Further, according to certain embodiments of the present disclosure, by removing the harmonic component generated when the DC link capacitance is reduced through the proportional resonance controller, it is possible to reduce the THD while reducing the DC link capacitance, thereby achieving cost reduction and product size reduction.

### BRIEF DESCRIPTION OF THE DRAWINGS

FIG. 1 is a circuit diagram for showing a system for outputting electric power of vehicle battery according to a embodiment of the present disclosure.

FIG. 2 is a graph for illustrating DC link capacitance and THD change with respect to input voltage ripple of a DC link.

FIG. 3 is a graph for illustrating a comparison between a V2L output command and an actual output voltage.

FIG. 4 is a graph for showing Fast Fourier Transform (FFT) analysis results of V2L output voltages.

FIG. 5 is a diagram for explaining the configuration of a controller shown in FIG. 1.

FIG. 6 is a graph for illustrating a vehicle plant model to which third harmonic control one of an embodiment of the present disclosure is not applied.

FIG. 7 is a graph for illustrating a vehicle plant model to which third harmonic control is applied according to an embodiment of the present disclosure.

FIG. 8 is a flowchart for illustrating a method of driving a system for outputting electric power of a vehicle battery according to an embodiment of the present disclosure.

FIG. 9 is a graph for illustrating DC link capacitance and THD change with respect to input voltage ripple of a DC link when third harmonic control is applied according to an embodiment of the present disclosure.

### DETAILED DESCRIPTION

Hereinafter, embodiments of the present disclosure will be described in detail with reference to the accompanying drawings so that those skilled in the art to which the present disclosure pertains can easily practice the present disclosure. Various changes may be applied to the present disclosure and the present disclosure may have various embodiments, and specific embodiments will be illustrated in the drawings and described in detail in the detailed description. However, this is not intended to limit the present disclosure to the specific embodiments, and it should be understood the present disclosure includes all modifications, equivalents, or substitutes included in the idea and technical scope of the present disclosure.

In order to clearly describe the present disclosure, parts irrelevant to the description are omitted in the drawings, and similar reference numerals are given to similar parts throughout the specification. In addition, while describing with reference to the drawings, even if components are indicated by the same name, the reference numeral may vary depending on each figure, and the reference numeral is only described for convenience of description, and the concept, characteristic, function, or effect of each component is not to be construed as limited by the corresponding reference numeral.

In describing the drawings, like reference numbers are used for like components. Terms, such as first, second, and the like, may be used to describe various components, but the components should not be limited by the terms. These terms are only used for the purpose of distinguishing one component from another. For example, a first component may be termed a second component, and similarly, the second component may be termed the first component, without departing from the scope of the present disclosure. The term “and/or” includes any combination of a plurality of related listed items or any item of the plurality of related listed items.

Unless defined otherwise, all terms used herein, including technical or scientific terms, have the same meaning as commonly understood by those skilled in the art to which the present disclosure pertains.

Terms such as those defined in commonly used dictionaries should be interpreted as having meanings consistent with the meanings in the context of the related art, and unless explicitly defined in the present specification, they should not be interpreted in ideal or excessively formal meanings.

Throughout the present specification, when it is described that a part is “connected” to another part, this includes not only the case of being “directly connected” but also the case of being “electrically connected” with another element in between. In addition, when it is described that a part “includes or comprises” a certain component, it means that the part may further include other components, not excluding other components unless otherwise stated, and it should be understood that the possibility of the presence or addition of one or more other characteristics, numbers, steps, operations, components, parts, or combinations thereof is not precluded.

In this specification, ‘unit’ or ‘module’ includes a unit implemented by hardware or software, or a unit realized using both. In addition, one unit may be implemented by using two or more hardware, and two or more units may be implemented by one hardware.

Hereinafter, a system for outputting electric power of a vehicle battery and a method for driving the same according to various embodiments of the present disclosure will be described in detail with reference to the accompanying drawings.

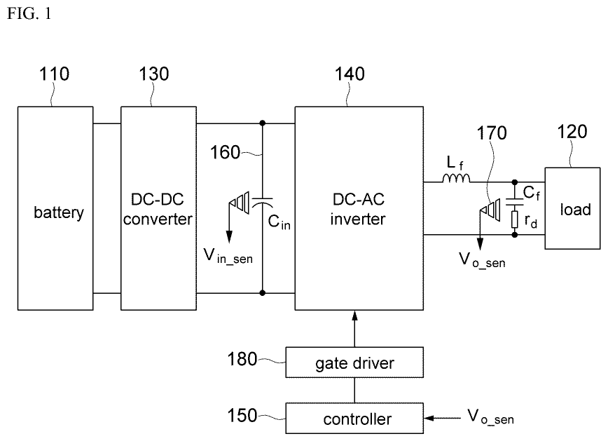

First, the system according to an embodiment of the present disclosure will be described with reference to FIGS. 1 to 4.

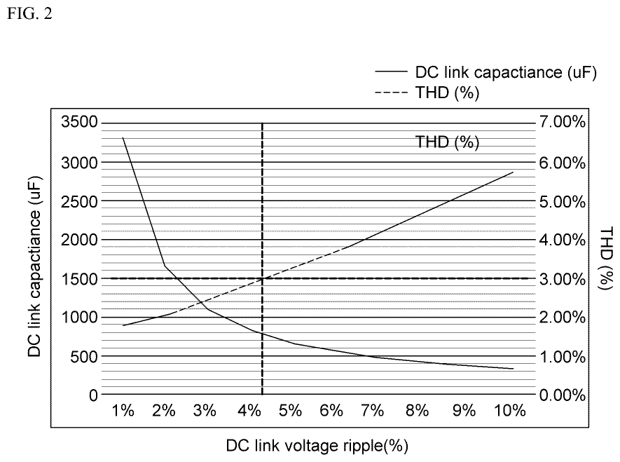

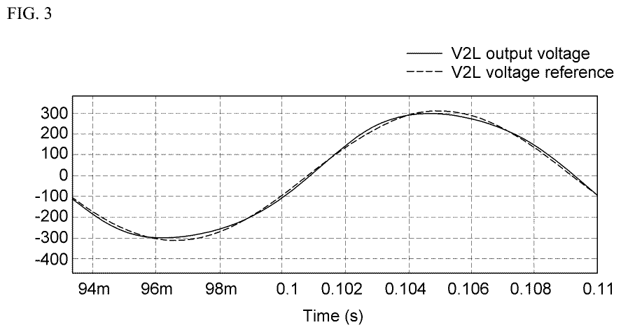

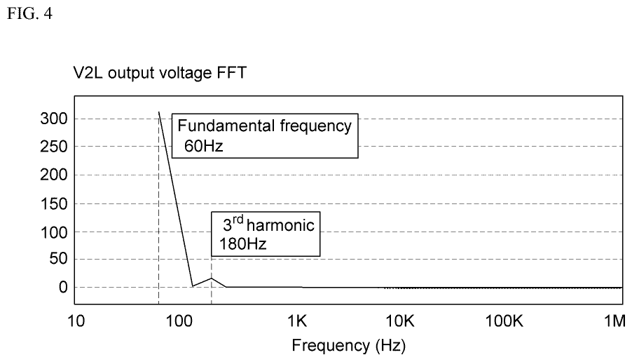

FIG. 1 is a circuit diagram for showing a system for outputting electric power of a vehicle battery according to an embodiment of the present disclosure, FIG. 2 is a graph for illustrating DC link capacitance and THD change with respect to input voltage ripple of a DC link, FIG. 3 is a graph for illustrating a comparison between a vehicle-to-load (V2L) output command and an actual output voltage, and FIG. 4 is a graph for showing Fast Fourier Transform (FFT) analysis results of V2L output voltages.

The system according to an embodiment of the present disclosure receives DC power energy from a battery 110, converts it into AC power energy, and then supplies it to a load 120.

The system according to an embodiment of the present disclosure may includes a DC-DC converter 130 configured to receive a DC current from the battery 110, included in a vehicle, and converting the received DC current into the other DC current, a DC-AC inverter 140 configured to convert the other DC current of the battery 110, converted by the DC-DC converter 130, into an AC current, a controller 150 configured to generate a control signal for controlling the DC-AC inverter 140 by receiving an output voltage (V_{o_sen}) and calculate a frequency modulation index (m) in which a harmonic component is controlled, and a DC link unit 160 connected or disposed between the DC-DC converter 130 and the DC-AC inverter 140 and including a capacitor Cᵢₙ. The output voltage (V_{o_sen}) may be, for example, but not limited to, a voltage associated with an output of the DC-AC inverter 140 such as a voltage of an output terminal of the DC-AC inverter 140 or a voltage having correlationship with the voltage of the output terminal of the DC-AC inverter 140.

The system may further include a voltage sensor 170 configured to detect the output voltage (V_{o_sen}) of the output terminal of the DC-AC inverter 140 and output the detected result to the controller 150, and a gate driver 180 configured to convert an output signal of the controller 150 into an analog signal to control the DC-AC inverter 140.

The DC-AC inverter 140 converts the DC current output from the DC-DC converter unit 130 into an AC current, and supplies the converted AC current to the load 120.

The DC link unit 160 is connected or disposed between the DC-DC converter 130 and the DC-AC inverter 140, and includes the capacitor Cᵢₙ to smooth the voltage output from the DC-DC converter 130.

The controller 150 receives the output voltage (V_{o_sen}) detected by the voltage sensor 170 and calculates a frequency modulation index (m) in which a third harmonic component is controlled, and generates a control signal for filtering a harmonic component of the output voltage of the DC-AC inverter 140 caused by input voltage ripple of the DC-AC inverter 140.

In other words, the controller 150 according to some embodiments of the present disclosure can control the DC-AC inverter 140 which uses a proportional resonance controller to reduce a change rate of THD (Total Harmonic Distortion) according to a decrease in DC link capacitance and improve THD.

That is, the DC link capacitance may be designed in consideration of reducing the harmonic component of the output voltage of the DC-AC inverter 140 caused by the input voltage ripple of the DC-AC inverter 140 as one factor. For example, in the case of a single-phase inverter, the capacitance of a DC link capacitor C_{DC} is selected to minimize the effect of V_{dcMAX} and V_{dcMIN} on THD due to the voltage ripple through the following Equation 1.

$$\frac{{P}_{0}}{ω} = {C}_{DC} ( {V}_{dcMAX}^{2} - {V}_{dcMIN}^{2} ) \qquad ( Equation 1 )$$

where P₀ is the output power of a system, for example, a vehicle to load (V2L) system, ω is an output voltage frequency (e.g., 60 Hz, etc.) of the V2L system, V_{dcMAX} is a maximum point voltage when considering the DC link voltage ripple, and V_{dcMIN} is a minimum point voltage when considering the DC link voltage ripple.

Referring to FIG. 2, when designing to have THD of 3% or less, a DC link capacitance of about 700 μF or more needs to be secured. The V2L system requires a large DC link capacitance, which increases the size of the system and manufacturing cost.

FIGS. 3 and 4 show that, as a result of FFT analysis of the output voltage in the case that a voltage ripple of 10% is allowed in a DC link, the third harmonic component is the main factor in increasing the THD. Accordingly, when the input voltage ripple is allowed, it is necessary to reduce the THD by reducing the third harmonic component.

Accordingly, certain embodiments of the present disclosure can remove the harmonic component (for instance, but not limited to, a third harmonic component) from the output voltage of the DC-AC inverter 140 using the proportional resonance controller which may be included in the controller 150, so that the harmonic component generated when the DC link capacitance is reduced can be removed or reduced and the THD can decrease. In addition, some embodiments of the present disclosure can reduce the THD while reducing the DC link capacitance by removing a harmonic component generated when the DC link capacitance is reduced through a proportional resonance controller, thereby achieving reduction to manufacturing cost and product size.

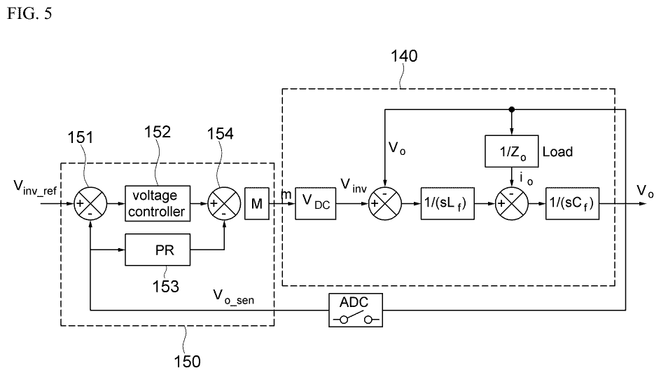

Then, the controller 150 of the system according to one embodiment of the present disclosure will be described in more detail with reference to FIGS. 5 to 7.

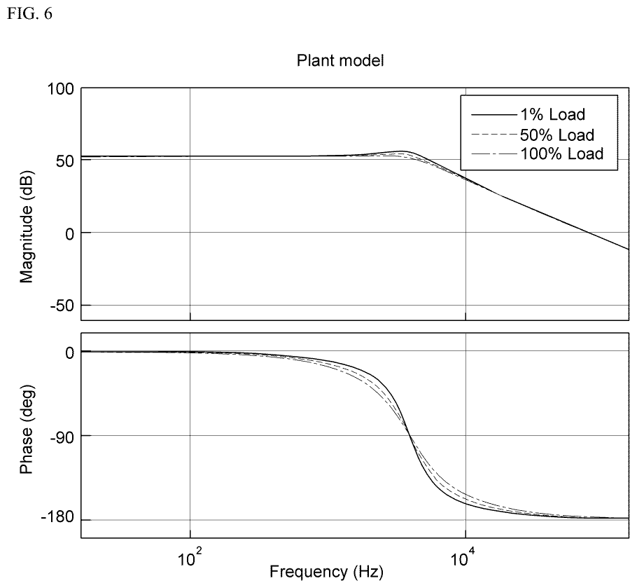

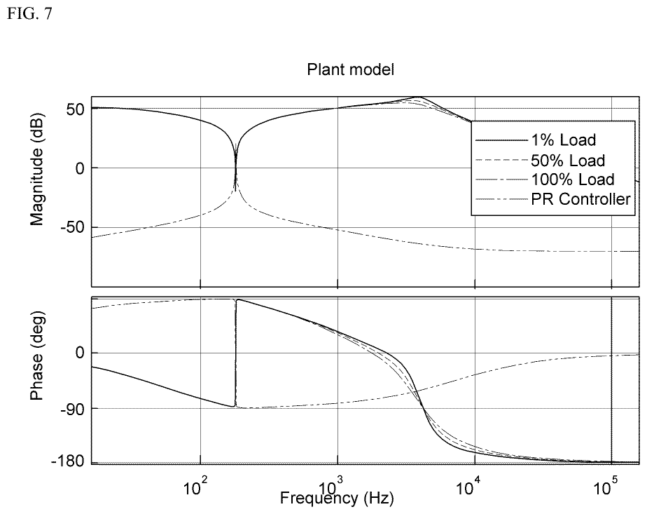

FIG. 5 is a diagram for explaining the configuration of the controller shown in FIG. 1, FIG. 6 is a graph for illustrating a vehicle plant model to which third harmonic control of a embodiment of the present disclosure is not applied, and FIG. 7 is a graph for illustrating a vehicle plant model to which third harmonic control is applied according to a embodiment of the present disclosure.

The controller 150 may calculate the frequency modulation index (m) by subtracting a harmonic modulation index from a voltage frequency modulation index.

For example, referring to FIG. 5, the controller 150 may include a first subtractor 151 configured to receive a reference voltage V_{inv_ref} and an output voltage V_{o_sen} detected by the voltage sensor 170 and subtract the output voltage V_{o_sen} from the reference voltage V_{inv_ref} to calculate an error or difference therebetween, a voltage controller 152 configured to receive the error calculated by the first subtractor 151 and calculate the voltage frequency modulation index by frequency modulation to the error or difference between the output voltage V_{o_sen} and the reference voltage V_{inv_ref}, a proportional resonance (PR) controller 153 configured to receive the output voltage V_{o_sen} detected by the voltage sensor 170 and calculate a harmonic modulation index by frequency modulation to the output voltage V_{o_sen}, and a second subtractor 154 configured to calculate a frequency modulation index m by subtracting the harmonic modulation index calculated by the proportional resonance controller 153 from the voltage frequency modulation index calculated by the voltage controller 152.

Referring to FIGS. 1 and 5, the controller 150 may generate a control signal for controlling the DC-AC inverter 140 by receiving the output voltage V_{o_sen} and calculating the frequency modulation index (m) in which a harmonic component is controlled.

The gate driver 180 may control the DC-AC inverter 140 by converting an output signal of the controller 150 into an analog signal. The gate driver 180 may output a pulse width modulation (PWM) control signal for controlling the DC-AC inverter 140 based on the frequency modulation index (m) output from the controller 150. Meanwhile, although the DC-AC inverter 140 is shown in FIG. 5 as being consisting of a single-phase inverter, this is only an example and the DC-AC inverter 140 may be made of any other types of inverters according to embodiments of the present disclosure.

Hereinafter, a control transfer function of the proportional resonance controller 153 for allowing the controller 150 to generate a control signal for filtering a harmonic component of the output voltage of the DC-AC inverter 140 caused by the input voltage ripple of the DC-AC inverter 140 will be described in detail.

The proportional resonance controller 153 may be a controller having a high gain for a specific frequency component and have higher control performance for the specific frequency component. According to an embodiment of the present disclosure, by using the characteristics of the proportional resonance controller 153 having a high gain for a specific frequency component, the control of the third harmonic component of the output voltage generated due to the DC link ripple can be performed. For example, referring to FIGS. 6 and 7, when the third harmonic component control is performed using the proportional resonance controller 153 according to an embodiment of the present disclosure, the third harmonic frequency component can be filtered in the vehicle plant model.

The gain PR of the proportional resonance controller 153 may be expressed by Equation 2 below.

$$PR = {K}_{p} + \frac{{K}_{i} {ω}_{c} s}{{s}^{2} + 2 {ω}_{c} s + {ω}_{z}^{2}} \qquad ( Equation 2 )$$

where Kₚ is a proportional constant for the error, Kᵢ is a gain at a resonant frequency, s is a frequency, ω_{c} is a cutoff frequency, and ω_{z} is the resonant frequency.

Further, the resonant frequency ω_{z} may be expressed by Equation 3 below.

$${ω}_{z} = 2 π {f}_{z} \qquad ( Equation 3 )$$

where f_{z} is a frequency of the harmonic component to be controlled. For example, when an output voltage fundamental frequency of the V2L system is “60 Hz”, f_{z} may be “180 Hz” which is the third harmonic of the output voltage fundamental frequency.

Further, the proportional constant Kₚ may be expressed by Equation 4 below.

$$20 log ( {K}_{p} ) < - x \qquad ( Equation 4 )$$

where x is a gain of the vehicle plant model. For example, x may be “50 dB”.

In addition, the gain Kᵢ at the resonant frequency may be determined using Equation 5 below.

$${\vert {G}_{PR} ( s ) \vert}_{{w}_{z}} \approx \frac{2 \cdot ( {K}_{i} + {K}_{p} ) \cdot {ω}_{z} \cdot {ω}_{c}}{2 \cdot {ω}_{z} \cdot {ω}_{c}} \approx {K}_{p} + {K}_{i} > 0 dB \qquad ( Equation 5 )$$

That is, the resonant frequency gain is determined such that the output at the resonant frequency point is cut off.

Further, the cutoff frequency ω_{c} may be determined using Equation 6 below.

$$1 \approx \sqrt{\frac{{( {K}_{i} {ω}_{c}^{2} )}^{2} + {( {K}_{i} {ω}_{c} σ )}^{2}}{{( {σ}^{2} + {ω}_{c}^{2} )}^{2}}} \qquad ( Equation 6 )$$

where σ is a passband at a resonant frequency point. That is, σ is a passband at the resonant frequency point, and the smaller the value σ, the narrower the passband appears at the resonant frequency, and the larger the value σ, the wider the passband appears near the resonant frequency. The narrower the passband, the narrower the control frequency range of resonance control is, and the wider the passband, the wider the control frequency range is. For example, when σ is set to “2 Hz” less than a vehicle reference value of “10 Hz”, that is, when the control range of the resonance controller is set to “2 Hz”, a more precise frequency range can be controlled than when set to “10 Hz”.

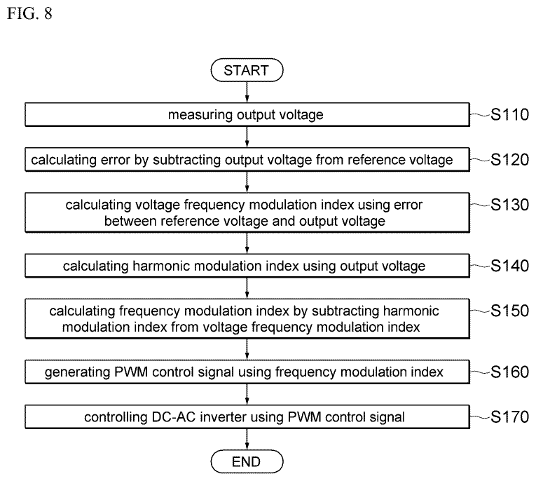

Next, a method for driving of the system according to one embodiment of the present disclosure will be described with reference to FIG. 8.

FIG. 8 is a flowchart illustrating a method for driving of a system for outputting electric power of a vehicle battery according to an embodiment of the present disclosure.

Referring to FIG. 8, the controller 150 may measure the output voltage V_{o_sen} through the voltage sensor 170 (Step S110). The output voltage V_{o_sen} may be, for example, but not limited to, a voltage associated with an output of the DC-AC inverter 140 such as a voltage of an output terminal of the DC-AC inverter 140 or a voltage having correlationship with the voltage of the output terminal of the DC-AC inverter 140.

Then, the controller 150 may calculate an error or difference by subtracting the output voltage V_{o_sen} from a reference voltage V_{inv_ref} through the first subtractor 151 (Step S120).

Then, the controller 150 may calculate a voltage frequency modulation index using the error or difference between the reference voltage V_{inv_ref} and the output voltage V_{o_sen}, calculated at Step S120, through the voltage controller 152 (Step S130).

Then, the controller 150 may calculate a harmonic modulation index using the output voltage V_{o_sen} through the proportional resonance controller 153 (Step S140). Here, the gain PR of the proportional resonance controller 153 may be expressed by Equation 2 provided above.

Then, the controller 150 may calculate a frequency modulation index (m) by subtracting the harmonic modulation index, calculated at Step S140, from the voltage frequency modulation index, calculated at Step S130, through the second subtractor 154 (Step S150).

Then, the controller 150 may generate a PWM control signal through the gate driver 180 using the frequency modulation index (m) input from the controller 150 (Step S160).

Then, the controller 150 may control the DC-AC inverter 140 using the PWM control signal through the gate driver 180 (Step S170).

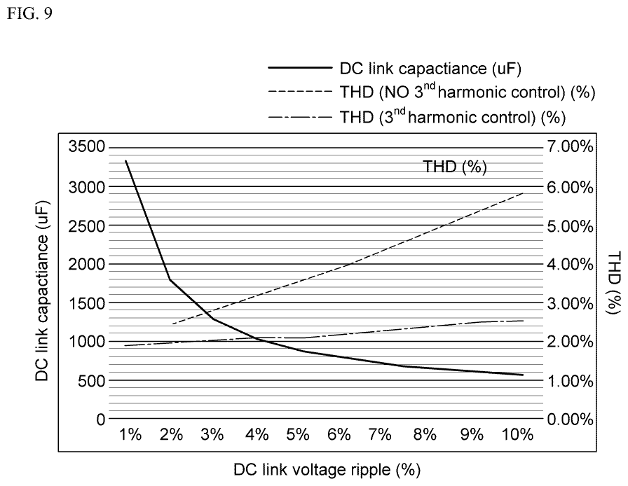

Next, the performance of the system according to one embodiment of the present disclosure will be described with reference to FIG. 9.

FIG. 9 is a graph for illustrating DC link capacitance and THD change with respect to input voltage ripple of a DC link when a third harmonic control is applied according to an embodiment of the present disclosure.

Referring to FIG. 9, the THD effect due to the DC link ripple can be reduced in an embodiment of the present disclosure in which the third harmonic component control is performed, compared to a conventional art in which the third harmonic component control is not performed. That is, some embodiments of the present disclosure can secure a low THD even with a DC link voltage ripple of 10%. Accordingly, certain embodiments of the present disclosure can use a DC link with a smaller capacitance compared to the conventional art, thereby reducing the size and volume of the system a manufacturing cost.

The above description of the present disclosure is for illustrative purposes, and those skilled in the art to which the present disclosure pertains may understand that it can be easily modified into other specific forms without changing the technical idea or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is defined by the following claims rather than the detailed description above, and all changes or modifications derived from the meaning and scope of the claims and equivalent concepts should be interpreted as being included in the scope of the present disclosure.

What is claimed is:

1. A system for controlling electric power of a vehicle battery, the system comprising:
a DC-DC converter configured to convert a DC current received from the vehicle battery into another DC current;
a DC-AC inverter configured to convert the another DC current, converted by the DC-DC converter, into an AC current;
a controller configured to generate a control signal for controlling the DC-AC inverter by calculating a frequency modulation index in which a harmonic component of an output voltage associated with an output of the DC-AC inverter is controlled; and
a DC link unit connected between the DC-DC converter and the DC-AC inverter and including a capacitor.

2. The system of claim 1, wherein the controller is configured to calculate the frequency modulation index based on a difference between a harmonic modulation index and a voltage frequency modulation index.

3. The system of claim 2, wherein the controller is configured to:
calculate an error between the output voltage, associated with the output of the DC-AC inverter, and a reference voltage;
calculate the voltage frequency modulation index by using the error between the output voltage and the reference voltage;
calculate the harmonic modulation index by using the output voltage; and
calculate the frequency modulation index based on the difference between the harmonic modulation index and the voltage frequency modulation index.

4. The system of claim 3, further comprising a gate driver configured to convert the control signal of the controller into an analog signal to control the DC-AC inverter.

5. The system of claim 4, wherein the gate driver is configured to output a pulse with modulation (PWM) control signal based on the frequency modulation index.

6. The system of claim 4, further comprising a voltage sensor configured to detect the output voltage of an output terminal of the DC-AC inverter and output the detected output voltage of the output terminal of the DC-AC inverter to the controller.

7. The system of claim 1, wherein the controller is configured to calculate a gain PR of a proportional resonance controller, included in the controller for calculating the harmonic modulation index, using Equation 1 below,
$$PR = {K}_{p} + \frac{{K}_{i} {ω}_{c} s}{{s}^{2} + 2 {ω}_{c} s + {ω}_{z}^{2}} \qquad ( Equation 1 )$$
where Kₚ is a proportional constant for an error between the output voltage and a reference voltage,
Kᵢ is a gain at a resonant frequency,
s is a frequency,
ω_{c} is a cutoff frequency, and
ω_{z} is the resonant frequency.

8. The system of claim 7, wherein the resonant frequency ω_{z} is calculated by Equation 2 below,
$${ω}_{z} = 2 π {f}_{z} \qquad ( Equation 2 )$$
where f_{z} is a frequency of the harmonic component of the output voltage to be controlled.

9. The system of claim 7, wherein the proportional constant Kₚ is calculated by Equation 3 below,
$$20 log ( {K}_{p} ) < - x \qquad ( Equation 3 )$$
where x is a gain of a vehicle plant model.

10. The system of claim 7, wherein the gain Kᵢ at the resonant frequency is calculated using Equation 4 below.
$${\vert {G}_{PR} ( s ) \vert}_{{w}_{z}} \approx \frac{2 \cdot ( {K}_{i} + {K}_{p} ) \cdot {ω}_{z} \cdot {ω}_{c}}{2 \cdot {ω}_{z} \cdot {ω}_{c}} \approx {K}_{p} + {K}_{i} > 0 dB \qquad ( Equation 4 )$$

11. The system of claim 7, wherein the cutoff frequency ω_{c} is calculated using Equation 5 below,
$$1 \approx \sqrt{\frac{{( {K}_{i} {ω}_{c}^{2} )}^{2} + {( {K}_{i} {ω}_{c} σ )}^{2}}{{( {σ}^{2} + {ω}_{c}^{2} )}^{2}}} \qquad ( Equation 5 )$$
where σ is a passband at a resonant frequency point.

12. The system of claim 1, wherein the controller is configured to calculate the frequency modulation index in which a third harmonic component of the output voltage associated with the output of the DC-AC inverter is controlled.

13. A method for driving of a system including a DC-DC converter configured to convert a DC current received from a vehicle battery into another DC current, a DC-AC inverter configured to convert the converted another DC current into an AC current, and a controller configured to control the DC-AC inverter, the method comprising:
calculating an error between an output voltage associated with an output of the DC-AC inverter and a reference voltage;
calculating a voltage frequency modulation index using the error between the reference voltage and the output voltage associated with the output of the DC-AC inverter;
calculating a harmonic modulation index using the output voltage associated with the output of the DC-AC inverter;
calculating a frequency modulation index, in which a harmonic component of the output voltage associated with the output of the DC-AC inverter is controlled, by using a difference between the harmonic modulation index and the voltage frequency modulation index; and
generating a control signal for controlling the DC-AC inverter using the frequency modulation index.

14. The method of claim 13, wherein:
the voltage frequency modulation index is calculated by frequency modulation, and
the harmonic modulation index is calculated by frequency modulation.

15. The method of claim 14, further comprising controlling the DC-AC inverter using the control signal.

16. The method of claim 13, wherein a gain PR of a proportional resonance controller for calculating the harmonic modulation index is calculated by using Equation 1 below,
$$PR = {K}_{p} + \frac{{K}_{i} {ω}_{c} s}{{s}^{2} + 2 {ω}_{c} s + {ω}_{z}^{2}} \qquad ( Equation 1 )$$
where Kₚ is a proportional constant for the error between the output voltage and the reference voltage,
Kᵢ is the gain at a resonant frequency,
s is a frequency,
ω_{c} is a cutoff frequency, and
ω_{z} is the resonant frequency.

17. The method of claim 16, wherein the resonant frequency ω_{z} is calculated by using Equation 2 below,
$${ω}_{z} = 2 π {f}_{z} \qquad ( Equation 2 )$$
where f_{z} is a frequency of the harmonic component to be controlled.

18. The method of claim 17, wherein the proportional constant Kₚ is calculated by using Equation 3 below,
$$20 log ( {K}_{p} ) < - x \qquad ( Equation 3 )$$
where x is a gain of a vehicle plant model.

19. The method of claim 18, wherein the gain Kᵢ at the resonant frequency is calculated using Equation 4 below.
$${\vert {G}_{PR} ( s ) \vert}_{{w}_{z}} \approx \frac{2 \cdot ( {K}_{i} + {K}_{p} ) \cdot {ω}_{z} \cdot {ω}_{c}}{2 \cdot {ω}_{z} \cdot {ω}_{c}} \approx {K}_{p} + {K}_{i} > 0 dB \qquad ( Equation 4 )$$

20. The method of claim 19, wherein the cutoff frequency ω_{c} is calculated using Equation 5 below,
$$1 \approx \sqrt{\frac{{( {K}_{i} {ω}_{c}^{2} )}^{2} + {( {K}_{i} {ω}_{c} σ )}^{2}}{{( {σ}^{2} + {ω}_{c}^{2} )}^{2}}} \qquad ( Equation 5 )$$
where σ is a passband at a resonant frequency point.
